(19) United States
(12) Patent Application Publication
(10) Pub. No.: US 2003/0101297 A1
(43) Pub. Date: May 29, 2003

(54) Dynamic request pacing in switch systems

(75) Inventors: James W. Allen, Georgetown, TX (US); Michael John Mayfield, Austin, TX (US); Alvan Wing Ng, Austin, TX (US)

Correspondence Address: Gregory W. Carr, Carr & Storm, L.L.P., 670 Founders Square, 900 Jackson Street, Dallas, TX, 75202, US

(73) Assignee: International Business Machines Corporation, Armonk, NY

(21) Appl. No.: 09/997,813

(22) Filed: Nov. 29, 2001

(51) Int. Cl. G06F 13/00

(52) U.S. Cl. 710/107

(57) ABSTRACT

An apparatus and method for preventing livelocks in a switched system with a switch, a distributed bus arbiter, a plurality of microprocessors, busses and associated bus request logic, comprising said system. The method comprises generating a plurality of requests, defining times between the requests, generating retries of the switches, and varying within the bus request logic, time as a function of the switch retries.

### BACKGROUND

In distributed microprocessing systems, typically the processor runs faster than the memory controller. In many systems today, to optimize performance, multiple processors on the system are interconnected via point-to-point busses through a switch. All the processors connected to a switch can transmit information across a bus. Typically, the first processor to request access to the bus is granted access to the bus for a predetermined time period. However, if more than one processor attempts to transmit information across the bus at the same time, the transmissions may overlap and become garbled.

Address bus arbitration rules are used for the switch to allocate time to a specific bus when there are multiple bus requests pending for use of the memory controller. Typically, the switch employs an arbitration scheme, such as giving use of the bus for one time period to each requesting processor in a defined order. While address bus arbitration rules such as these are designed to be fair and can be used to eliminate many sources of conflict and confusion, problems can arise due to internal conflicts. The acceptance of command requests by the switch is a function of its resource availability. If the switch has the resources to accept the commands from the bus, they are forwarded to the memory controller. If the busses issue too many requests at once, the switch may become saturated. If this is the case, then the switch will issue a resource retry to the busses that transmitted a request which the switch was too full to handle. The retired busses must then resubmit the requests. However, in some situations a cyclical access pattern can be developed. Because each bus only gets a particular time block, it may make a request that cannot be accepted at the time block allowed.

If the bus cannot finish submitting a request to the switch, it will continue to retry submitting that request to the switch for processing. If the other busses connected to the switch are also very busy, the switch may become locked in a cycle of not being able to complete forwarding that request, but continuously retry the request. As a result, that switch will not process any other requests from that particular bus, but continuously retry the same request over and over. This is called a livelock condition. This livelock condition may result in the system generating an error condition.

Accordingly, a continuing search has been directed to the development of systems and methods which can avoid or resolve livelock conditions.

### SUMMARY

The present invention, accordingly, provides a system and method that involves varying the time allocated to process a bus request as a function of the number of retries requested by that switch without a given number of requests on that switch being completed.

One embodiment of the present invention comprises a method for preventing starvation in a switched system with a distributed bus arbiter, whereby the bus arbiter increases the time between a request from a microprocessor connected to the switched system to use resources of a switch until the switch can process the request; and the bus arbiter decreases the time between the requests from the microprocessors connected to the switched system to use resources of the switch as a function of some number of requests processed without the bus arbiter having to increase the time between requests from the microprocessors connected to the switched system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a high-level conceptual block diagram of a microprocessor system that could experience system livelock;

FIG. 2 is a representative chart showing bus operations over time in a microporcessor system;

FIG. 3 is a high-level conceptual block diagram illustrating a portion of a microprocessor system incorporating the bus arbitration rules of the present invention to reduce livelocks; and

FIG. 4 is a flow chart representing the processing flow utilizing the bus arbitration rules of the present invention.

### DETAILED DESCRIPTION

In the discussion of the FIGURES the same reference numerals will be used throughout to refer to the same or similar components. In the interest of conciseness, well-known elements and details, such as timing considerations and the like have been omitted inasmuch as such details are not considered necessary to obtain a complete understanding of the present invention, and are considered to be within the skills of persons of ordinary skill in the relevant art.

In switched systems with a distributed arbiter, resource starvation issues can be a problem due to the fact that the processors are faster than the memory controller. The acceptance of the requests by the switch is a function of its resource availability. If the switch has sufficient resources available, a requester will be granted access to the switch via a bus. However, if the switch is full, access to the switch will be denied to that requester. An arbiter is a logic circuit that delays granting bus access to a requester in response to a signal from the switch that it is full. Most arbiters are designed to use some form of “round-robin” arbitration, wherein the most recent requester that has been granted access will become last in line to gain access again, and the least recent requester that has a request pending will be the next to be granted access to the switch. This logic is designed to ensure that each requester has equal access to the bus and switch. While this arbitration logic is designed to provide fairness to all bus requesters, the arbitration method does not always function ideally in every situation, given the complex nature of the bus pipeline and the interaction of the busses with the switch.

For example, when a requesting processor receives a message that the switch is full, that requesting processor will continue to request access to the switch until the switch has sufficient resources to grant the request. In the meantime, one or more additional requesters, on the same processor or another processor connected to the bus are also seeking access to the switch. It is possible for a set of requests to the switch to be generated by the requesters, resulting in retries and acknowledgements such that one of the requesting entities is always retried. A simple sequence of events of this type would occur when two processors, A and B, are attempting to access data at the same address and a switch allows a single access only to a particular address at any one time. Processor A would gain access to the switch causing a snoop process to start. At this time, processor B would attempt to access data at the same address and be retried by the switch. Since processor B is attempting access to the same address it will snoop retry processor A. The sequence of activities on the bus by other processors and the switch can be such that the processor A and B requests are presented to the switch in the same order and are thus always retried. It is therefore possible to generate a cyclical access pattern whereby a particular transaction is always retried by the switch and thus does not complete. This condition is known as “livelock.”

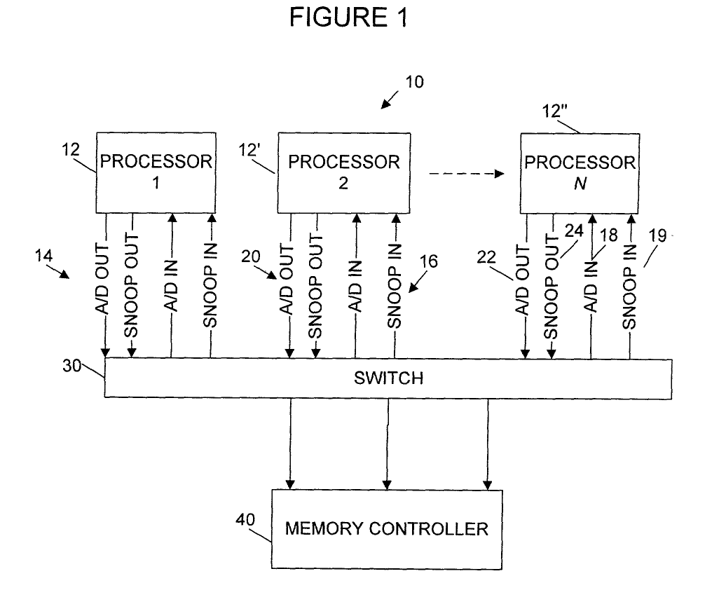

FIG. 1 represents a typical system configuration 10 that could experience the resource starvation livelock. This configuration 10 is composed of one to n processors 12 interconnected via point-to-point busses 14 through a switch 30. The bus 14 is narrow, high speed, pipelined and consists of input-only 16 and output-only 20 portions. Each input-only 16 portion of the bus has a set of input address/data signals 18 and a set of snoop input response signals 19. Each output-only 20 portion of the bus has a set of output address/data signals 22 and a set of snoop output response signals 24. This allows true simultaneous input and output operation. One or more processors 12 output a request onto the bus 14. If the switch 30 has the resources to accept the request, the request is forwarded to the Memory Controller 40. The requests are reflected to all processors 12 starting the address snoop process 19, 24. However, if the switch 30 does not have the resources to accept a request, that requesting processor 12 is refused access to the bus 14 by the bus arbiter, and the requesting processor must request access again. Additional requests may be put in the queue prior to the requesting processor that was denied being able to complete the steps necessary to make a re-request.

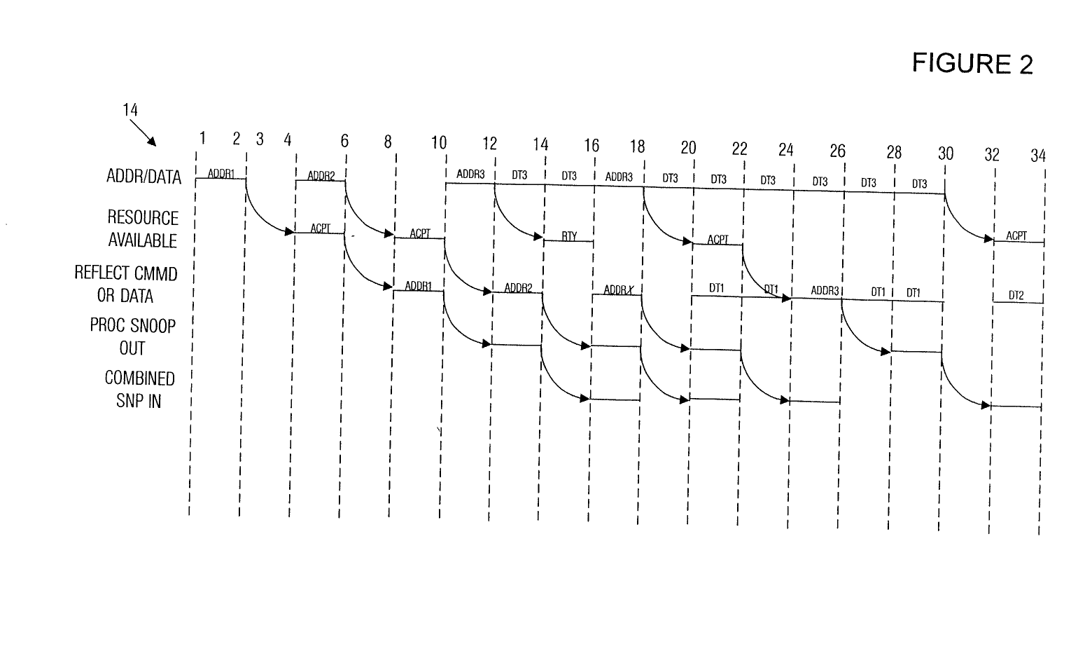

FIG. 2 shows a typical simple sequence of activities on a typical bus subject to livelock. FIG. 2 depicts thirty-four cycles on a particular bus 14, during which time three requests from a single processor 12 along with a reflected request from another processor 12′ are received on the bus. The first request is a load request, Addr1, which occurs in cycles 1 and 2. The Addr1 load request command takes 2 cycles. The Addr1 command is accepted the first time it is requested, at cycles 5 and 6. Due to other activity on the bus, the actual data transfer does not commence until cycle 21, and then continues until all the data is loaded. The time this load takes will vary based on other activity on the bus, and the size of the data stream being loaded. The second request is also a load request, Addr2, which occurs at cycles 5 and 6. The Addr2 load request command takes 2 cycles. The Addr2 command is accepted the first time it is requested, at cycles 9 and 10. Due to other activity on the bus, the actual data transfer does not commence until cycle 17, and then continues until all the data is loaded.

The third request a store command, Addr3, immediately followed by its data, Dt3, first occurs in cycles 11 and 12. Due to the heavy utilization of the system at that cycle, the switch lacks the resources to process the request, so the request is refused access to the bus 14 by the bus arbiter. The requesting processor must request access again, which it does at cycles 17 and 18. The Addr3 store request command takes 2 cycles. The Addr3 command is accepted on the retry request, at cycles 21 and 22, and the data, Dt3, follows immediately. Note that a reflected command from another processor 12′ for Addrx, appears on the Reflected Command portion of this bus at cycles 17 and 18. Also, the reflected commands Addr1, Addr2 and Addr3 from processor 12 appear respectively at cycles 9 and 10, 13 and 14, and 25 and 26. All five of these commands will be snooped by processor 12. The snoop result out from processor 12 for commands Addr1, Addr2, Addrx and Addr3 appears at cycles 13 and 14, 17 and 18, 21 and 22, and 29 and 30 respectively. Next, the snoop results from all processors are combined by the memory controller 40 and returned to processor 12 as the combined snoops for commands Addr1, Addr2, Addr3 and Addrx in cycles 17 and 18, 21 and 22, 25 and 26, and 33 and 34 respectively.

All of these request operations generate reflected snoops, snoop result out, and combined snoop result in activity. Although not depicted in FIG. 2, the snoops could also be retried, causing the associated request operation to be restarted from the beginning. Thus, in such a highly pipelined system, where multiple processors 12 source commands to the switch 30, commands may be accepted or rejected by the switch depending on address 18, 22 and snoop 19, 24 resources. Due to the high complexity of the bus 14 and number of simultaneous activities, it is expected there will be a peak demand for switch resources 30, causing momentary resource starvation that could livelock. The bus arbiter also affects how the requests are presented to the bus 14. Even though the arbitor provides equal access to the bus 12, it's complex pipelined nature and it's interaction with the switch resources 30 may create a situation where it is possible to generate a cyclical access pattern.

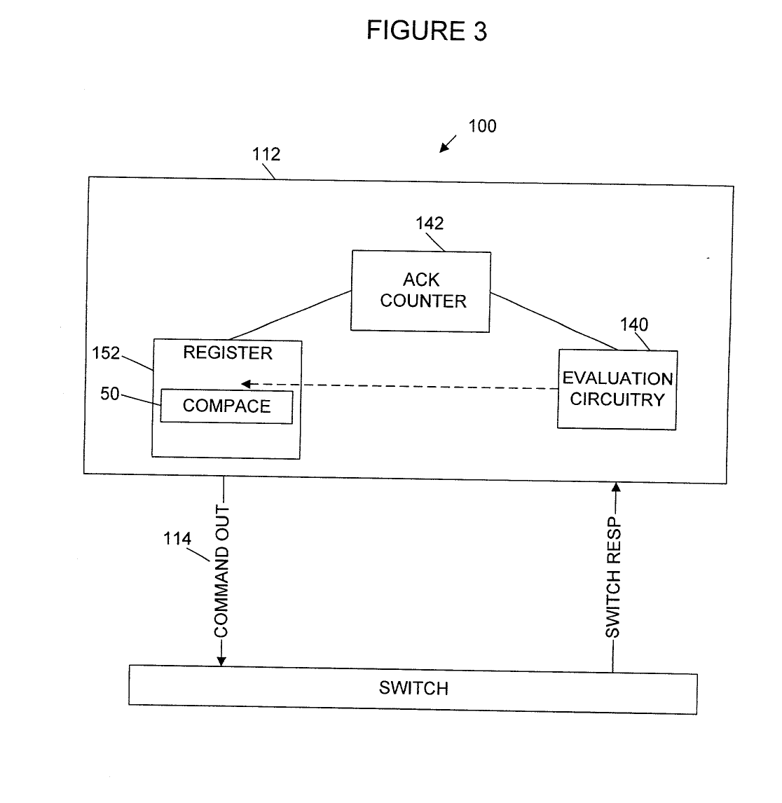

FIG. 3 depicts a system 100 of the present invention that is designed to alleviate livelock occurrences in switched systems with distributed arbiters. To control request operation interactions, a new parameter, COMPACE 50, is defined in the bus parameters and stored in a register on the processor. COMPACE 50 is the basic unit used to vary the command issue rate to the bus 114. COMPACE 50 is programmed at power-on to specify the number of bus clocks between issue of commands to the bus 114. After a request, such as a load, store, or control operation is issued onto the bus 114, the processor 112 waits a number of bus logic clocks equal to the value of COMPACE 50 to issue the next command to the bus 114. For example, if COMPACE is set to four, the number of bus clocks between issuing commands to the bus 114 will be four. This allows the system to set up an average optimum command issue rate such that there is a balance between issue rate and resource retries to minimize time between command completions.

The processor 112 requests access to the switch 130 (not labeled) through the bus 114, waiting a number of bus clocks between issuing commands equal to the value of COMPACE 50. The switch 130 responds to the processor 112 request, indicating whether it has the resources available to process the request, or whether the request should be retried. Evaluation circuitry 140 on the processor 112 evaluates each response. If the response is that the request should be retried, then the evaluation circuitry 140 sends a message to the register 152 storing the COMPACE 50 value to increment the number stored in the register 152 by a number equal to the value at which COMPACE 50 was originally set. For example, if COMPACE 50 is originally set to four, the number of bus clocks between commands is four. After one retry response, the register 152 will be instructed by the evaluation circuitry 140 to increase by one COMPACE 50, and there will be 8 bus clocks between each command. Each sequential retry response will add one additional COMPACE 50 delay, up to a maximum of 256 bus clocks, to the register 152 until the switch 130 responds to the evaluation circuitry 140 indicating it has resources available to process the request. By increasing the number of bus clocks between commands, the system 100 will get additional time to process requests or load data.

When the switch 130 responds to the evaluation circuitry 140 indicating that it has resources available to process a request, that resource available response is logged into an acknowledgement counter 142. When the number in the acknowledgement counter 142 equals a number that can be programmed or defined at startup to different values, the number of clock periods between commands is decreased by one COMPACE 50. For example, if the number of acknowledge responses is set to 3 at power-on, then the value in the register 152, and thus the number of bus clocks between commands, will be decreased by 1 COMPACE 50 after the evaluation circuitry 140 logs three sequential commands without a retry response into the acknowledgement counter 142. This cycle continues until the value in the register 152 is reduced to one COMPACE 50. If a retry is received, the delay between commands is again increased by one COMPACE 50

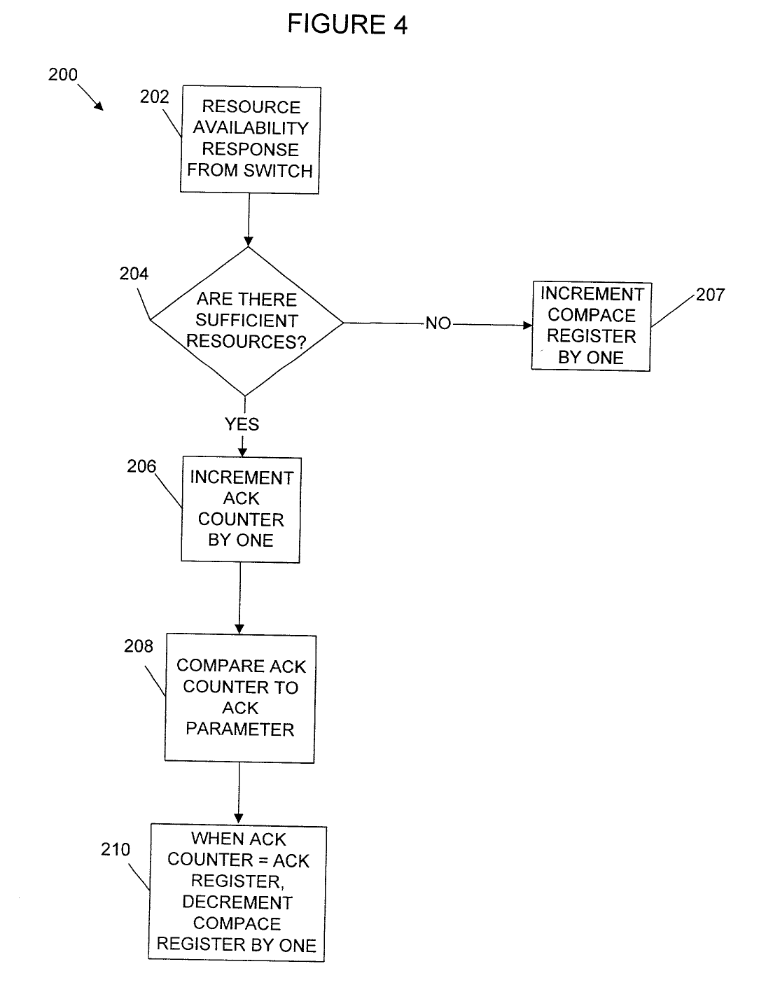

FIG. 4 shows the logic flow 200 that occurs utilizing the bus arbitration rules of the present invention when a bus inquires if the switch has sufficient resources to handle a request. In step 202, the switch sends a resource response to the microprocessor indicating if it has sufficient resources to handle the request. In step 204, the software evaluates the response from the switch. If the switch acknowledges that it has sufficient resources to handle the request, then at step 206 the counter used to track the number of acknowledgements is incremented by 1. At step 208, the number is the acknowledgement counter is compared to the number of acknowledgements defined at power-on that must be received from the switch without a retry. When the number in the counter equals the predefined number of acknowledgements, at step 210, the delay, or number of bus logic clocks between commands is decremented by one COMPACE, to a minimum of one COMPACE.

If at step 204 the switch requested a retry, indicating it did not have sufficient resources to handle the request, then at step 207, then a command is sent to the register storing the COMPACE value to increment the number stored in the register by a number equal to the value at which COMPACE was originally set at power-on, up to a maximum of 256 bus clocks. This will increase the number of bus clock cycles between command issuance to the switch by the number of bus cycles defined to equal one COMPACE at power-on.

It is further noted that, unless indicated otherwise, all functions described herein are performed by a processor such as a computer or electronic data processor in accordance with code such as computer program code, software, or integrated circuits that are coded to perform such functions.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method to prevent starvation in a switched system comprising a distributed bus arbiter that varies a time between a request for the switched system resources as a function of a number of requests the system indicates to be retried.

2. The method of claim 1 further comprising the bus arbiter first increasing the time between requests until the system no longer indicates to retry the request and the bus arbiter then decreasing the time between requests after a number of requests processed without the system indicating to retry any requests.

3. A method for preventing starvation in a switched system with a distributed bus arbiter, the method comprising:
a) the bus arbiter increasing a time between a request from a microprocessor connected to the switched system to use resources of a switch until the switch can process the request; and
b) the bus arbiter decreasing the time between the requests from the microprocessors connected to the switched system to use resources of the switch as a function of some number of requests processed without the bus arbiter having to increase the time between requests from the microprocessors connected to the switched system.

4. A method for avoiding livelocks in a switched system with a distributed bus arbiter, whereby bus request logic varies a time between requests for resources of the switched system as a function of switch retries, the method comprising:
a) defining a first parameter that specifies a number of bus clocks to wait between requests from a microprocessor connected to the switched system;
b) defining a second parameter that specifies a number of sequential responses to be received from a system switch indicating it has a sufficient number of resources to process the request issued from the microprocessor connected the switched system;
c) issuing at least one request from the microprocessor to the system switch;
d) responsive to a signal from the system switch indicating it lacks resources to process a command, increasing the number of bus clocks to wait between issuance of requests from microprocessors by the number of bus clocks defined as the first parameter;
e) waiting the increased number of bus clocks between issuance of requests to the switch;
f) responsive to a signal from the system switch indicating it has resources to process a command, increasing a counter counting the number of signals from the system switch indicating it has resources to process a command;
g) responsive to a signal from the system switch indicating it lacks resources to process a command, resetting the value in the counter to zero;
h) comparing the value in the counter to the second parameter; and
i) when the value in the counter is equal to the value of the second parameter, decreasing the number of bus clocks between issuance of requests to the switch from microprocessors connected to the switched system by the amount equal to the number of bus clocks defined as the first parameter and resetting the value in the counter to zero.

5. The method of claim 4 wherein the first parameter is defined at system power-on.

6. The method of claim 4 wherein the second parameter is defined at system power-on.

7. A distributed bus arbiter in a switched system that prevents livelocks, the bus arbiter varying the time between a request for the switched system resources as a function of a number of requests the switched system indicates to be retried.

8. The apparatus of claim 7 further comprising the bus arbiter first increasing the time between requests until the system no longer indicates to retry the request and the bus arbiter then decreasing the time between requests after a number of requests processed without the system indicating to retry any requests.

9. A distributed bus arbiter for use in a switched system that prevents livelocks, the system comprising:
a) the bus arbiter increasing a time between a request from a microprocessor connected to the switched system to use resources of a switch until the switch can process the request; and
b) the bus arbiter decreasing the time between the requests from the microprocessors connected to the switched system to use resources of the switch as a function of some number of requests processed without the bus arbiter having to increase the time between requests from the microprocessors connected to the switched system.

10. A distributed bus arbiter apparatus for preventing livelocks in a switched system by varying a time between requests for system resources as a function of switch retries, the apparatus comprising:
a) means for defining a first parameter to specify a number of bus clocks to wait between processing requests from a microprocessor connected to the switched system;
b) means for defining a second parameter to specify a number of sequential responses to be received from a system switch indicating it has a sufficient number of resources to process the request issued from the microprocessor connected the switched system;
c) means for issuing at least one request from the microprocessor to the system switch;
d) means for issuing a signal from the system switch indicating it lacks resources to process a command,
e) responsive to the signal from the system indicating it lacks resources to process a command, means for increasing the number of bus clocks to wait between issuance of requests by an amount equal to the first parameter;
f) means for waiting the increased number of bus clocks between issuance of requests to the switch;
g) means, responsive to a signal from the system switch indicating it has resources to process a command, for increasing a counter counting the number of signals from the system switch indicating it has resources to process a command;
h) means, responsive to a signal from the system switch indicating it lacks resources to process a command, for resetting the value in the counter to zero;
i) means for comparing the value in the counter to the second parameter; and
j) means for decreasing the number of bus clocks between issuance of requests to the switch from microprocessors by the amount equal to the number of bus clocks defined as the first parameter and resetting the value in the counter to zero when the value in the counter is equal to the value of the second parameter.

11. The apparatus of claim 10 further comprising means for defining the first parameter at system power-on.

12. The apparatus of claim 10 further comprising means for defining the second parameter at system power-on.

13. A computer program product for preventing livelocks in a switched system with a distributed bus arbiter, the computer program comprising:
a) computer program code for increasing a time between a request from a microprocessor connected to the switched system to use resources of a switch until the switch can process the request; and
b) computer program code for decreasing the time between the requests from the microprocessors to use resources of the switch as a function of some number of requests processed without the bus arbiter having to increase the time between requests from the microprocessors connected to the switched system.

14. A computer program product for preventing livelocks in a switched system by varying a time between requests for system resources as a function of the number of requests to be retried due to lack of system resources, the computer program product comprising:
a) computer program code for defining a first parameter to specify a number of bus clocks to wait between processing requests from a microprocessor connected to the switched system;
b) computer program code for defining a second parameter to specify a number of sequential responses to be received from a system switch indicating it has a sufficient number of resources to process the request issued from the microprocessor;
c) computer program code for issuing requests from the microprocessor to the system switch;
d) computer program code for the system switch to indicate it lacks resources to process a command,
e) computer program code for increasing the number of bus clocks to wait between issuance of requests by an amount equal to the first parameter responsive to the system switch indicating it lacks resources to process a command;
f) computer program code for the system to increase a counter counting the number of signals from the system switch responsive to the system indicating it has resources to process a command;
g) computer program code for resetting the value in the counter to zero responsive to a signal from the system switch that it lacks resources to process a command;
h) computer program code for comparing the value in the counter to the second parameter;
i) computer program code for decreasing the number of bus clocks between issuance of requests to the switch from microprocessors by the amount equal to the number of bus clocks defined as the first parameter; and
j) computer program code for resetting the value in the counter to zero when the value in the counter is equal to the value of the second parameter.
